(19) United States
(12) Patent Application Publication
(10) Pub. No.: US 2002/0100319 A1
(43) Pub. Date: Aug. 1, 2002

(54) Measuring device of the surface level of liquid

(75) Inventor: Yao Chi Yang, Fengshan City (TW)

Correspondence Address: LOWE HAUPTMAN GOPSTEIN GILMAN & BERNER, LLP, Suite 310, 1700 Diagonal Road, Alexandria, VA, 22314, US

(73) Assignee: ADVANCED SEMICONDUCTOR ENGINEERING INC.

(21) Appl. No.: 09/770,391

(22) Filed: Jan. 29, 2001

(51) Int. Cl. G08B 21/00

(52) U.S. Cl. 73/304 R; 340/620

(57) ABSTRACT

A measuring device to measure the surface level of liquids comprises a pair of probes each having a conductive body and an isolated coating layer enclosing the conductive body in such a manner that onlya little portion of the body is exposed outside of the coating layer; and a measuring circuit connected to the pair of the probes. The measuring circuit is provided with a power source, an amplifier circuit and an alarm device. When the surface level of the liquid passes through the exposed portion of the body of the probes during measuring, the change of the electrical property between the pair of the probes will be magnified to actuate the alarm device.

### BACKGROUND OF THE INVENTION

1. Field of the Invention

This invention relates to a measuring device of the surface level of liquids, and more specifically to a measuring device of the surface level of a specific liquid material.

2. Description of the Related Art

It is well known in the prior art that a variety of devices can be use to measure the surface level of liquids. In general, the devices include two metal probes which are submerged into the liquid for measuring. Due to the conductivity of the liquid, the resistance between the two metal probes will be varied according to the depth of the probes submerged in the liquid and the resistance is usually proportion to the submerged depth. According to this property, a circuit is provided to measure the resistance between the two probes , and thus the submerged depth of the two probes can be detected. Furthermore, as the surface level of the liquids has been lower than the bottom end of the probes, the circuit would be an open-circuit. For the some specific liquids, such as pure water, high concentration hydrogen peroxide (H₂O₂) solution, the difference of the conductivity between the liquid and the gas with saturation vapor of the liquid above the liquid is insignificant. Thus, if the conventional metal probes are used to measure the surface level of the specific liquid, such as pure water, and high concentration hydrogen peroxide, the circuit would not validly respond to the change of surface level of the liquid and the height of the surface level of the liquid could not be accurately measured.

Also, the hydrogen peroxide is a strong oxidizer and is an essential chemical material for industrial processing. If the probe is made of the common metal, the metal probe would be often corroded by the hydrogen peroxide, thereby resulting in malfunction or damage of the probe due to the high oxidation of the hydrogen peroxide. Because of the surface tension between the probe and the hydrogen peroxide solution, when the surface level of the hydrogen peroxide solution is lower than the bottom end of the probe, some of the hydrogen peroxide solution will adhere to the probe such that an open circuit between the two probes can not be formed in the measuring circuit and the conductivity therebetween cannot be accurately measured. Furthermore, due to the high oxidation of the hydrogen peroxide solution, the voltage and the current between the two probes must be limited to avoid increasing the oxidation of the hydrogen peroxide solution.

Therefore, a need exists for the level measuring device industry to provide a suitable measuring device to measure the surface level for specific liquids and give an alarm when the surface level thereof is lower than a predetermined level.

### SUMMARY OF THE INVENTION

It is the primary object of the present invention to provide a measuring device to measure the surface level of the given liquid in which the difference of the conductivity between the liquid and the gas with saturation vapor of the liquid above the liquid is insignificant.

It is the secondary object of the present invention to provide a measuring device to give an alarm when the surface level is lower than a predetermined level.

In order to achieve the objects mentioned hereinabove, the measuring device to measure the surface level of a liquid according to the present invention comprises:

a pair of probes each having a conductive body and an isolated coating layer enclosing the conductive body in such a manner that only a little portion of the body is exposed outside of the coating layer; and

a measuring circuit connected to the pair of probes , and the measuring circuit having a power source, an amplifier circuit and an alarm device, wherein when the surface level of the liquid passes through the exposed portion of the body of the probes during measuring, the change of the electrical signal between the pair of probes will be magnified to actuate the alarm device.

According to one aspect of the present invention, the exposed portion of the body of the probe is preferably less than 2 mm, and most preferably less than 1 mm.

According to another aspect of the present invention, the body of the probe is preferable made of an anti-oxidative metal, such as titanium, platinum and gold, and it is made preferably of stainless steel.

According to the present invention, since the measuring device provides a measuring circuit having an amplifier circuit to magnify the signal and the probes provide a small sensor surface, even though the difference of the electrical property between the liquid and the gas above the liquid is insignificant, the surface level of the liquid can be detected by the present invention.

### BRIEF DESCRIPTION OF THE DRAWINGS

Other objects, advantages, and novel features of the invention will become more apparent from the following detailed description when taken in conjunction with the accompanying drawings.

FIG. 1 is a schematic view of a measuring device to measure the surface level of liquid according to the present invention.

FIG. 2 is a circuit diagram of the measuring circuit of the measuring device to measure the surface level of liquid according to the present invention.

### DETAILED DESCRIPTION OF THE PREFERRED EMBODIMENT

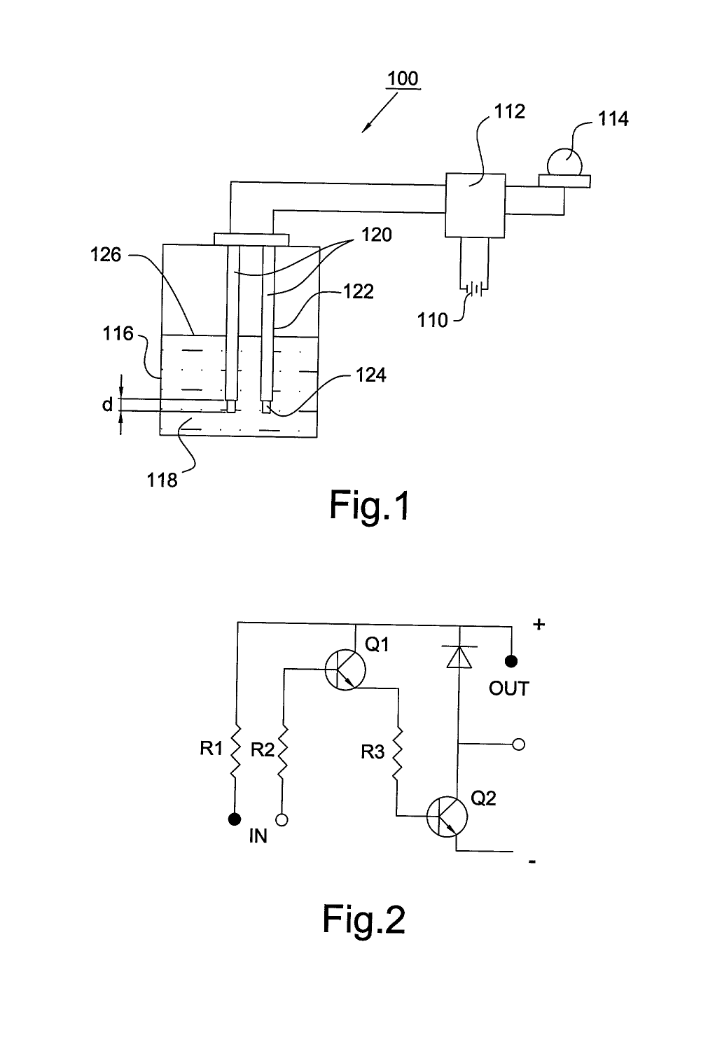

Now referring to FIG. 1, it depicts a measuring device 100 to measure the surface level of liquid according to the present invention. The measuring device 100 includes a power source 110, a measuring circuit 112, an alarm 114, and two probes 120. The two probes of the measuring device 100 are connected electrically to the measuring circuit 112 for transmit the electrical signals of measuring to the circuit 112. The power source 110 is used to supply electrical power to the circuit 112.

The measuring device 100 is described in detail hereinafter, and it will be illustrated to measure the surface level of hydrogen peroxide solution. It should be understood that the measuring device 100 according to the present invention would be used to measure the other liquids, such as pure water. The two probes 120 of the measuring circuit 112 are attached into a sealed container 116, and they are used to measure the surface level 126 of liquid (hydrogen peroxide solution) 118.

The two probes 120 of the measure device 100 according to the present invention are submerged into the hydrogen peroxide solution 118 for measure the surface level 126 of the solution 118. The probe 120 has a metal body 124 and a coating layer 122 enclosing the body 124. It should be noted that, because of the high oxidation of the hydrogen peroxide solution, the coating layer 122 of the probe 120 is made of anti-oxidative isolated material, such as Teflon and epoxy, the body 124 of the probe 120 is made of anti-oxidative metal, such as titanium, platinum and gold, and it is made economically preferably of stainless steel.

Furthermore, since the difference of the conductivity between the hydrogen peroxide solution 118 and the gas portion of the sealed container 116 is insignificant, the esposed portion of the body 124 of the probes 120 uncovered with the coating layer 122 must be limited. Preferably, the exposed distance of the body 124 (as shown in FIG. 1) is less than 2 mm and, more preferably less than 1 mm. Besides, since the coating layer 122 can prevent the hydrogen peroxide solution 118 from adhering to the body 124 of the probe 120, the surface tension effect of the hydrogen peroxide solution 118 will be minimized such that the electrical property between the two probes 120 can be accurately measured.

When the hydrogen peroxide solution 118 is consumed gradually, and the surface level 126 would be lower than the body 124 of the probe 120, and then the change of the electrical property between the two probes 120 would occur, and the measuring circuit 112 can magnify this change to actuate an alarm 114, thereby warning that the surface level 126 of the hydrogen peroxide solution 118 is lower than an alarm position set by the two probes 120. The alarm 114 can be a siren or alarm lights, or the alarm 114 can be connected to an auto-controller to automatically refill the sealed container 116 with the liquid 118 while the surface level 126 of the liquid 118 is lower than the body 124 of the two probes 120.

Referring to FIG. 2, it depicts a circuit diagram of the measuring circuit 112 according to the present invention which includes an amplifier circuit and a power source. The input (IN) of the amplifier circuit is connected to the two probes 120 and the output (OUT) of the amplifier circuit is connected to the alarm 114. As shown in the drawing, the amplifier circuit comprises two transistors to amplify the difference of the electrical property between the hydrogen peroxide solution 118 and the gas portion detected by the two probes 120 such that the alarm 114 can be actuated. It should be understood by those skilled in the art that the measuring circuit 112 can be easily adapted to a variety of given liquids. For example, as the measuring device 100 is applied to hydrogen peroxide solution, the voltage and the current between the sensor sticks 120 of the measuring device 100 must be limited to avoid increasing the oxidation of the hydrogen peroxide solution.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A measuring device to measure the surface level of liquids, comprising:
a pair of probes each having a conductive body and an isolated coating layer enclosing the conductive body in such a manner that only a little portion of the body is exposed outside of the coating layer; and
a measuring circuit connected to the pair of probes, and the measuring circuit having a power source, an amplifier circuit and an alarm device, wherein when the surface level of the liquid passes through the exposed portion of the body of the probe during measuring, the change of the electrical property between the pair of probes will be magnified to actuate the alarm device.

2. The measuring device of claim 1, wherein the exposed portion of the body of the probe is less than 2 mm.

3. The measuring device of claim 1, wherein the exposed portion of the body of the probe is less than 1 mm.

4. The measuring device of claim 1, wherein the conductive body of the probe is made of an anti-oxidative metal.

5. The measuring device of claim 4, wherein the anti-oxidative metal is selected from the group consisting of titanium, platinum, gold, and stainless steel.

6. The measuring device of claim 4, wherein the anti-oxidative metal is stainless steel.

7. The measuring device of claim 1, wherein the alarm device is a siren.

8. The measuring device of claim 1, wherein the alarm device is an alarm light.

9. The measuring device of claim 1, wherein the alarm device is an auto-controller for automatically refilling the liquid.

10. The measuring device of claim 1, wherein the coating layer of the probe is made of Teflon.

11. The measuring device of claim 1, wherein the coating layer of the probe is made of epoxy.

12. The measuring device of claim 1, wherein the measured liquid is hydrogen peroxide solution.

13. The measuring device of claim 1, wherein the measured liquid is pure water.
